(19) United States
(12) Patent Application Publication
(10) Pub. No.: US 2025/0200862 A1
(43) Pub. Date: Jun. 19, 2025

(54) TOKENIZING A SCENE GRAPH USING ONE-HOT TOKEN VECTORS AND METADATA

(71) Applicant: Roblox Corporation, San Mateo, CA (US)

(72) Inventors: Tijmen VERHULSDONCK, Göteborg (SE); Haomiao JIANG, San Mateo, CA (US); Marcel VAN WORKUM, Vancouver (CA); Joseph LIU, San Mateo, CA (US); Reza NOURAI, Danville, CA (US); Mahesh Kumar NANDWANA, Sunnyvale, CA (US); Ziyu GUO, San Mateo, CA (US); Behnam BASTANI, San Mateo, CA (US)

(73) Assignee: Roblox Corporation, San Mateo, CA (US)

(21) Appl. No.: 18/979,360

(22) Filed: Dec. 12, 2024

Related U.S. Application Data
(60) Provisional application No. 63/610,868, filed on Dec. 15, 2023.

(51) Int. Cl. G06T 15/00

(52) U.S. Cl. CPC G06T 15/005

(57) ABSTRACT

A token engine may receive a data file that describes a three-dimensional (3D) virtual environment using tags for attributes in the 3D virtual environment. The token engine generates a set of one-hot token vectors from the tags in the data file and a set of metadata vectors from metadata in the data file, where one or more metadata vectors in the set of metadata vectors correspond to one or more one-hot token vectors in the set of one-hot token vectors. The token engine combines the set of one-hot token vectors and the set of metadata vectors. The token engine provides a combined set of one-hot token vectors and metadata vectors as input to a deep-learning model.

### CROSS-REFERENCE TO RELATED APPLICATIONS

This application is a non-provisional application that claims priority under 35 U.S.C. § 119(e) to U.S. Provisional Patent Application No. 63/610,868, titled TOKENIZING A SCENE GRAPH USING ONE-HOT TOKEN VECTORS AND METADATA and filed on Dec. 15, 2023, which is hereby incorporated by reference herein in its entirety.

### TECHNICAL FIELD

This disclosure relates generally to communications and computer graphics, and more particularly but not exclusively, relates to methods, systems, and computer readable media to tokenize a data file.

### BACKGROUND

A virtual environment is a simulated three-dimensional environment generated from graphical data. The virtual environment may be described by different attributes including objects with different locations, dimensions, colors, etc. The virtual environment may be stored as a data file, such as an extensible Markup Language (XML) file.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Embodiments relate generally to a system and method to tokenize a data file using one-hot vectors and metadata. A computer-implemented method includes receiving a data file that describes a three-dimensional (3D) virtual environment, where the data file includes tags for attributes in the 3D virtual environment. The method further includes generating a set of one-hot token vectors from the tags in the data file. The method further includes generating a set of metadata vectors from metadata in the data file, where one or more metadata vectors in the set of metadata vectors correspond to one or more one-hot token vectors in the set of one-hot token vectors. The method further includes combining the set of one-hot token vectors and the set of metadata vectors. The method further includes providing a combined set of one-hot token vectors and metadata vectors as input to a deep-learning model.

In some embodiments, the set of metadata vectors includes areas that are reserved for one or more floating-point vectors. In some embodiments, the one or more floating-point vectors are associated with predetermined sizes that fit data associated with one or more selected from a group of a coordinate frame, an initial size, a current size, a mesh identifier, light, image textures, a mesh part, audio, a networking service, and combinations thereof. In some embodiments, a metadata vector in the set of metadata vectors that is associated with a one-hot token vector that lacks metadata includes metadata features that are set to zero to indicate an absence of metadata. In some embodiments, the deep-learning model outputs one or more selected from a group of a recommendation to generate content in the 3D virtual environment, an identification of a terms of service violation, a scene enhancement in the 3D virtual environment, an optimal performance setting, a streaming priority for a mesh in the 3D virtual environment, and combinations thereof. In some embodiments, the deep-learning model is trained using training data that includes a plurality of one-hot token vectors that are fused to a plurality of metadata vectors. In some embodiments, the data file is of a filetype is selected from a group of an XML, JSON, YAML, and Universal Scene Description (USD). In some embodiments, the tags in the data file include a tag for a name, and the method further comprises before generating the set of one-hot token vectors, removing the tag for the name and the name from the data file. In some embodiments, the set of one-hot token vectors and the set of metadata vectors are combined using a fuse operation.

According to one aspect, a system includes a processor and a memory coupled to the processor, with instructions stored thereon that, when executed by the processor, cause the processor to perform operations comprising: receiving a data file that describes a 3D virtual environment, where the data file includes tags for attributes in the 3D virtual environment; generating a set of one-hot token vectors from the tags in the data file; generating a set of metadata vectors from metadata in the data file, where one or more metadata vectors in the set of metadata vectors correspond to one or more one-hot token vectors in the set of one-hot token vectors; combining the set of one-hot token vectors and the set of metadata vectors; and providing a combined set of one-hot token vectors and metadata vectors as input to a deep-learning model.

In some embodiments, the set of metadata vectors includes areas that are reserved for one or more floating-point vectors. In some embodiments, the one or more floating-point vectors are associated with predetermined sizes that fit data associated with one or more selected from a group of a coordinate frame, an initial size, a current size, a mesh identifier, light, image textures, a mesh part, audio, a networking service, and combinations thereof. In some embodiments, a metadata vector in the set of metadata vectors that is associated with a one-hot token vector that lacks metadata includes metadata features that are set to zero to indicate an absence of metadata. In some embodiments, the deep-learning model is selected from a group of a large language model, a natural language processing model, and combinations thereof. In some embodiments, wherein the deep-learning model is trained using training data that includes a plurality of one-hot token vectors that are fused to a plurality of metadata vectors.

According to one aspect, non-transitory computer-readable medium with instructions that, when executed by one or more processors at a user device, cause the one or more processors to perform operations, the operations comprising: receiving a data file that describes a 3D virtual environment, where the data file includes tags for attributes in the 3D virtual environment; generating a set of one-hot token vectors from the tags in the data file; generating a set of metadata vectors from metadata in the data file, where one or more metadata vectors in the set of metadata vectors correspond to one or more one-hot token vectors in the set of one-hot token vectors; and providing a combined set of one-hot token vectors and metadata vectors as input to a deep-learning model.

In some embodiments, the set of metadata vectors includes areas that are reserved for one or more floating-point vectors. In some embodiments, the one or more floating-point vectors are associated with predetermined sizes that fit data associated with one or more selected from a group of a coordinate frame, an initial size, a current size, a mesh identifier, light, image textures, a mesh part, audio, a networking service, and combinations thereof. In some embodiments, a metadata vector in the set of metadata vectors that is associated with a one-hot token vector that lacks metadata includes metadata features that are set to zero to indicate an absence of metadata. In some embodiments, the deep-learning model is selected from a group of a large language model, a natural language processing model, and combinations thereof.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications; and all such modifications are within the scope of this disclosure.

### BRIEF DESCRIPTION OF THE DRAWINGS

FIG. 1 illustrates an example three-dimensional virtual environment, according to some embodiments described herein.

FIG. 2 is a block diagram of an example network environment, according to some embodiments described herein.

FIG. 3 is an example diagram of a conventional method to generate tokens and a new method to generate tokens, according to some embodiments described herein.

FIG. 4A is an example of a mesh part that is described by extensible markup language data, according to some embodiments described herein.

FIG. 4B is an example of how the XML data in FIG. 4A is tokenized to include one-hot token vectors and metadata vectors to reduce the number of tokens, according to some embodiments described herein.

FIG. 5 is an example method to combine a set of one-hot token vectors and a set of metadata vectors, according to some embodiments described herein.

FIG. 6 is an example flow diagram of an example method to generate a combined set of one-hot token vectors and metadata vectors, according to some embodiments described herein.

FIG. 7 is a block diagram illustrating an example computing device, according to some embodiments described herein.

### DETAILED DESCRIPTION

A scene graph is a spatial representation of a graphical scene that is organized as a collection of nodes in a graph or a tree structure that represents different entities and entity properties. The entities may include a three-dimensional (3D) mesh part, lights, sound emitters, scripts, networking services, etc. that are used to create an interactive, immersive, and connected 3D experience.

In some embodiments, a computing device converts a scene graph into an extensible Markup Language (XML) file and the XML file may be tokenized using Byte Pair Encoding (BPE). BPE works by creating tokens from the text in the XML file, where one token corresponds to one or more characters in the text. Tokenized text has extensive applications in conjunction with machine-learning models.

BPE currently has two limitations. First, BPE supports text data and does not support other modalities of data, such as images, audio, and 3D meshes. Second, BPE is not efficient at tokenizing XML files. This issue is exacerbated when the XML file includes a lot of floating-point numbers.

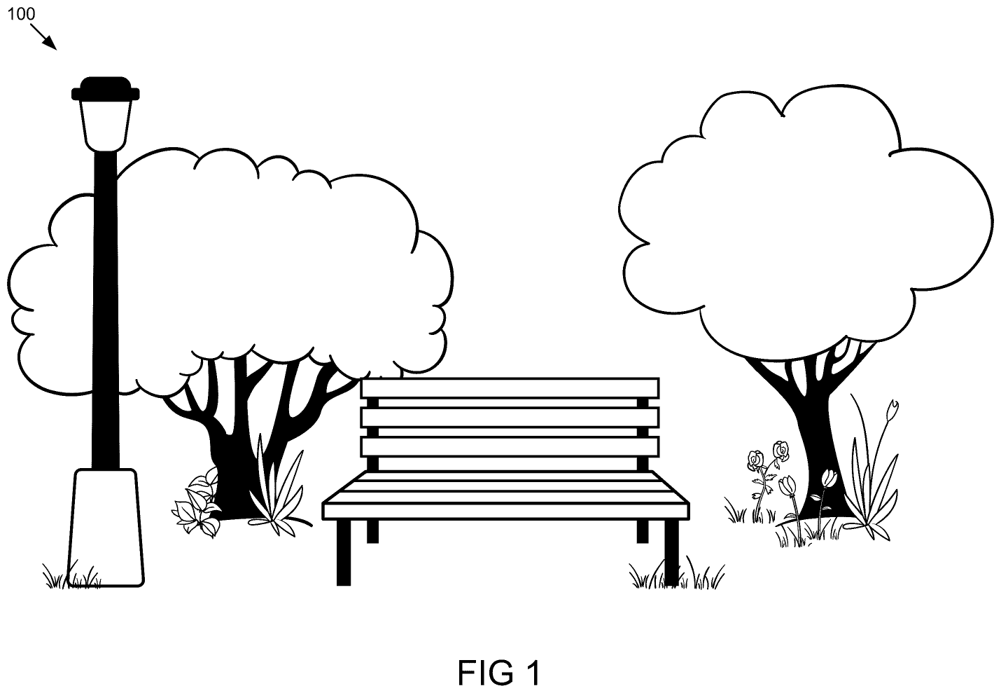

FIG. 1 illustrates one example of a 3D graphical scene 100. The 3D graphical scene 100 includes 3D meshes, audio emitters, and textures. In the XML file, non-textual data, such as the 3D meshes, audio data, and textures are represented by a uniform resource language (URL). A client device may render the 3D graphical scene 100 by fetching the non-textual data using the URLs associated with each entity.

Tokenizing a serialized XML file of the 3D graphical scene 100 in FIG. 1 could result in approximately 28,000 tokens, which can be prohibitively large for use by a machine-learning model. For example, large language models (LLMs) support a maximum of about 32,000 tokens. Even the simple scene in FIG. 1 has a scene graph that, when tokenized using conventional methods, can be unusable for a majority of use cases that utilize LLMs or other machine learning techniques. For use cases pertaining to virtual experiences (e.g., any type of immersive space where an avatar may view virtual objects in 3D and move within the space), the actual scene may be much more complex than the simple example of FIG. 1 and hence have a much larger scene graph. Thus, current tokenization techniques are inadequate and unsuitable for such applications. Additionally, per the conventional techniques, non-textual data is represented as tokenized versions of respective URLs, which results in the loss of any modality-specific information.

In some embodiments, the technology described herein advantageously solves the problem of creating unfeasibly large numbers of tokens and the problem of operating on multimodal data by using a custom tokenization method that represents a 3D scene with a far lower number of tokens, e.g., an order of magnitude less tokens than conventional techniques. The tokenization method includes generating one-hot token vectors for tags in a data file and corresponding metadata vectors for metadata, such as floating-point numbers. This allows for multimodal input and reduces the number of tokens needed to represent a 3D scene. Thus, the number of tokens generated during tokenization is reduced from around 28,000 tokens using a serialized XML file of the graphical scene in FIG. 1 to 519 tokens using the tokenization technique described below.

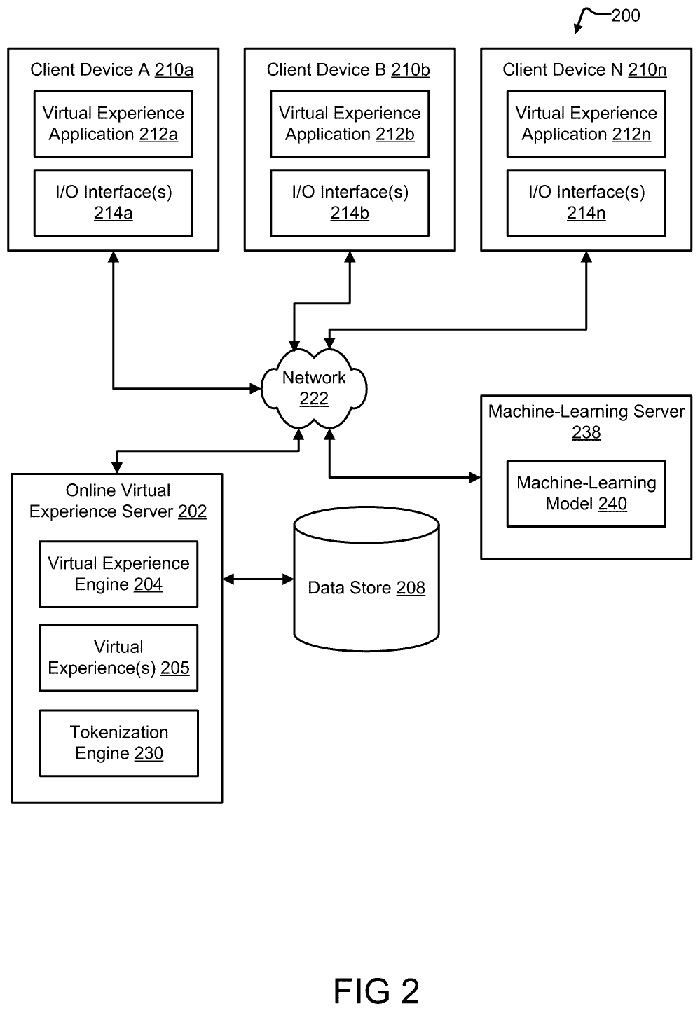

FIG. 2 illustrates an example network environment 200, in accordance with some embodiments of the disclosure. FIG. 2 and the other figures use like reference numerals to identify like elements. A letter after a reference numeral, such as “210a,” indicates that the text refers specifically to the element having that particular reference numeral. A reference numeral in the text without a following letter, such as “210,” refers to any or all of the elements in the figures bearing that reference numeral (e.g., “210” in the text refers to reference numerals “210a,” “210b,” and/or “210n” in the figures).

The network environment 200 (also referred to as a “platform” herein) includes an online virtual experience server 202, a data store 208, a client device 210 (or multiple client devices), and a machine-learning server 238, all connected via a network 222.

The online virtual experience server 202 can include, among other things, a virtual experience engine 204, one or more virtual experiences 105, and a tokenization engine 230. The online virtual experience server 202 may be configured to provide virtual experiences 205 to one or more client devices 110, and to provide tokenization functionality via the tokenization engine 230, in some embodiments.

Data store 208 is shown coupled to online virtual experience server 202 but in some embodiments, can also be provided as part of the online virtual experience server 202. The data store may, in some embodiments, be configured to store advertising data, user data, engagement data, and/or other contextual data in association with the tokenization engine 230.

The client devices 210 (e.g., 210a, 210b, 210n) can include a virtual experience application 212 (e.g., 212a, 212b, 212n) and an I/O interface 214 (e.g., 214a, 214b, 214n), to interact with the online virtual experience server 202, and to view, for example, graphical user interfaces (GUI) through a computer monitor or display (not illustrated). In some embodiments, the client devices 210 may be configured to execute and display virtual experiences, which may include virtual user engagement portals as described herein.

Network environment 200 is provided for illustration. In some embodiments, the network environment 100 may include the same, fewer, more, or different elements configured in the same or different manner as that shown in FIG. 2.

In some embodiments, network 222 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof.

In some embodiments, the data store 208 may be a non-transitory computer readable memory (e.g., random access memory), a cache, a drive (e.g., a hard drive), a flash drive, a database system, or another type of component or device capable of storing data. The data store 208 may also include multiple storage components (e.g., multiple drives or multiple databases) that may also span multiple computing devices (e.g., multiple server computers).

In some embodiments, the online virtual experience server 202 can include a server having one or more computing devices (e.g., a cloud computing system, a rackmount server, a server computer, cluster of physical servers, virtual server, etc.). In some embodiments, a server may be included in the online virtual experience server 202, be an independent system, or be part of another system or platform. In some embodiments, the online virtual experience server 202 may be a single server, or any combination a plurality of servers, load balancers, network devices, and other components. The online virtual experience server 202 may also be implemented on physical servers, but may utilize virtualization technology, in some embodiments. Other variations of the online virtual experience server 202 are also applicable.

In some embodiments, the online virtual experience server 202 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 202 and to provide a user (e.g., user 214 via client device 210) with access to online virtual experience server 202.

The online virtual experience server 202 may also include a website (e.g., one or more web pages) or application back-end software that may be used to provide a user with access to content provided by online virtual experience server 202. For example, users (or developers) may access online virtual experience server 202 using the virtual experience application 212 on client device 210, respectively.

In some embodiments, online virtual experience server 202 may include digital asset and digital virtual experience generation provisions. For example, the platform may provide administrator interfaces allowing the design, modification, unique tailoring for individuals, and other modification functions. In some embodiments, virtual experiences may include two-dimensional (2D) games, three-dimensional (3D) games, virtual reality (VR) games, or augmented reality (AR) games, for example. In some embodiments, virtual experience creators and/or developers may search for virtual experiences, combine portions of virtual experiences, tailor virtual experiences for particular activities (e.g., group virtual experiences), and other features provided through the virtual experience server 202.

In some embodiments, online virtual experience server 202 or client device 210 may include the virtual experience engine 204 or virtual experience application 212. In some embodiments, virtual experience engine 204 may be used for the development or execution of virtual experiences 205. For example, virtual experience engine 204 may include a rendering engine (“renderer”) for 2D, 3D, VR, or AR graphics, a physics engine, a collision detection engine (and collision response), sound engine, scripting functionality, haptics engine, artificial intelligence engine, networking functionality, streaming functionality, memory management functionality, threading functionality, scene graph functionality, or video support for cinematics, among other features. The components of the virtual experience engine 204 may generate commands that help compute and render the virtual experience (e.g., rendering commands, collision commands, physics commands, etc.).

The online virtual experience server 202 using virtual experience engine 204 may perform some or all the virtual experience engine functions (e.g., generate physics commands, rendering commands, etc.), or offload some or all the virtual experience engine functions to virtual experience engine 204 of client device 210 (not illustrated). In some embodiments, each virtual experience 205 may have a different ratio between the virtual experience engine functions that are performed on the online virtual experience server 202 and the virtual experience engine 204 functions that are performed on the client device 210.

The tokenization engine 230 may receive a data file that describes the 3D virtual environment, for example, from the virtual experience engine 204. The data file uses tags for attributes in the 3D virtual environment. The tokenization engine 230 may generate a set of one-hot token vectors from the tags in the data file. The tokenization engine 230 may generate a set of metadata vectors from metadata in the data file, where one or more metadata vectors in the set of metadata vectors correspond to one or more one-hot token vectors in the set of one-hot token vectors. The tokenization engine 230 may combine the set of one-hot token vectors and the set of metadata vectors. The tokenization engine 230 may provide a combined set of one-hot token vectors and metadata vectors as input to the machine-learning server 238.

The machine-learning server 238 hosts a machine-learning model 240, such as a deep-learning model. In some embodiments, the machine-learning model 240 is trained based on training data that includes one-hot token vectors and metadata vectors. In some embodiments, the machine-learning model 240 is a Large Language Model (LLM) that receives a prompt from, for example, the virtual experience engine 204 and provides a response. The machine-learning model 240 may receive a prompt for a scene graph that matches characteristics described in the prompt. The machine-learning model 240 identifies one or more scene graphs that match the prompt and provides the response to the virtual experience engine 204. The scene graph may be used by the virtual experience engine 204 to generate a virtual experience 205.

In some embodiments, virtual experience instructions may refer to instructions that allow a client device 210 to render gameplay, graphics, and other features of a virtual experience 205. The instructions may include one or more of user input (e.g., physical object positioning), character position and velocity information, or commands (e.g., physics commands, rendering commands, collision commands, etc.).

In some embodiments, the client device(s) 210 may each include computing devices such as personal computers (PCs), mobile devices (e.g., laptops, mobile phones, smart phones, tablet computers, or netbook computers), network-connected televisions, gaming consoles, etc. In some embodiments, a client device 210 may also be referred to as a “user device.” In some embodiments, one or more client devices 210 may connect to the online virtual experience server 202 at any given moment. It may be noted that the number of client devices 210 is provided as illustration, rather than limitation. In some embodiments, any number of client devices 210 may be used.

In some embodiments, each client device 210 may include an instance of the virtual experience application 212. The virtual experience application 212 may be rendered for interaction at the client device 210. During user interaction within a virtual experience or another GUI of the online platform 200, a user may create an avatar that includes different body parts from different libraries.

The virtual experience engine 204 may generate an instance that hosts a specific place for a virtual experience 205. The virtual experience application 212 on the client device 210 joins the virtual experience 205 by maintaining a connection to the online virtual experience server 202 for the particular virtual experience 205.

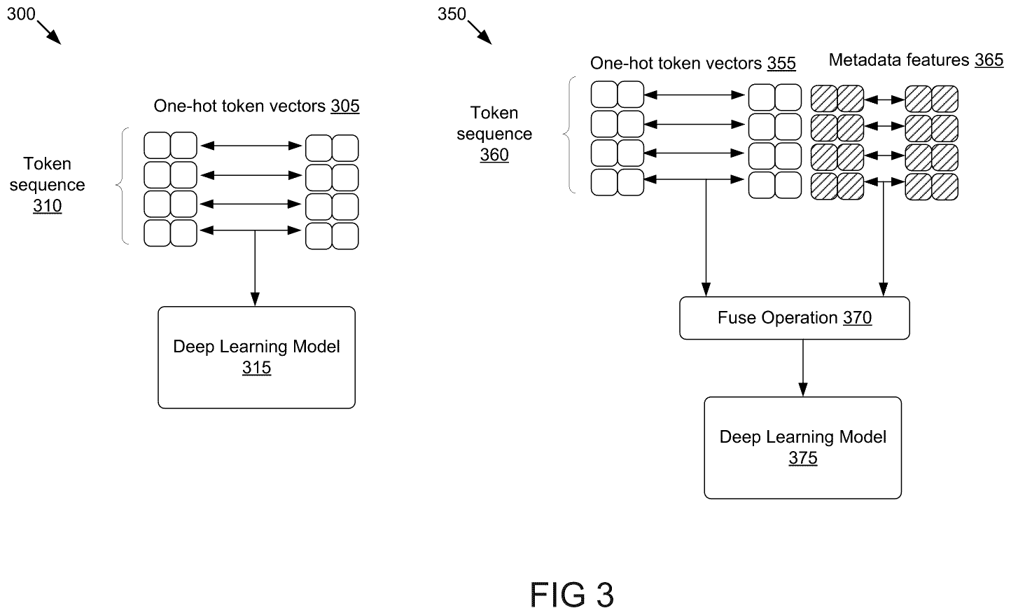

FIG. 3 is an example diagram of a conventional method 300 to generate token vectors and another method 350 to generate token vectors. Per the conventional method 300, a data file is tokenized to create one-hot token vectors 305. The data file may be XML data and the one-hot token vectors 305 may be created using BPE. For example, in an XML structure <Item class=“MeshPart”>, the XML structure results in seven tokens. Specifically, the seven tokens are <, Item, class,=”, Mesh, Part, and “>. Although the examples below are described with reference to XML data, the techniques may be used with other data file types, such as JSON, YAML, or a Universal Scene Description (USD).

A one-hot token vector is a 1×N matrix (i.e., a vector) that is used to distinguish each word in a vocabulary from every other word in the vocabulary by using Os in all cells except a 1 in one cell that is used to uniquely identify the word (one-hot refers to only one cell having a value of 1 in any vector). The 0s and 1s are indexed such that the location of the 1 is mapped to a key that identifies the corresponding word. For example, where a group of BaseParts includes: TrussPart, SpecialMesh, BlockMesh, WedgePart, MeshPart, and Part, a one hot vector of the BaseParts may be represented as 0, 0, 0, 0, 1, 0 to represent the six different BaseParts. MeshPart is indexed with a 1 at position 4 (i.e., the 1 is in the fifth place in the vector where indexes start at 0). As a result, instead of using BPE to create seven tokens to represent <Item class=“MeshPart”>, using the one-hot token vector maps the MeshPart to a single token.

In the simple example above, the tokenization is reduced slightly. However, the results are additive for a scene that includes many different objects with different attributes. In addition, attributes may be represented by many more variants. For example, in describing the materials in a scene, 45 different materials may exist, such as plastic, wood, marble, slate, limestone, etc. In this example, wood may be in located at position 4 out of 45, where the position indicate 45 different types of material.

A scene is represented by a set of one-hot token vectors 305. The one-hot token vectors 305 may be combined to form a token sequence 310. In this example, the token sequence 310 includes four one-hot token vectors 305. The token sequence 310 may be represented in a matrix of one-hot token vectors 305. The token sequence 310 (e.g., as a matrix) may be provided as input to a deep learning model 315.

Method 350 similarly tokenizes the data file to create one-hot token vectors 355. The one-hot token vectors 355 may be combined to form a token sequence 360. The token sequence 360 may be a matrix of token vectors. The token sequence 360 is combined with metadata features 365. In some embodiments, the one-hot token vectors are appended with the metadata features 365.

The matrix of token vectors is combined with a matrix of metadata features 365 using a fuse operation 370 as illustrated in FIG. 3. The fuse operation may take a variety of forms including single-matrix multiplication and output from a deep neural network. The deep neural network may include different layers, such as convolutions and transformers.

In some embodiments, some of the token vectors do not have metadata. For those cases, the row in the metadata features for the corresponding token may be set to zero. For example, a combined one-hot token vector and metadata vector with no metadata may be 0, 0, 1, 0, 0, 0, 0, 0 for the one-hot token vector and 0, 0, 0 for the metadata vector.

The fuse operation 370 may output a fused matrix. The fused matrix may be provided as input to a deep-learning model 375. The deep-learning model 375 may be a machine-learning model that uses the fused matrix for a variety of applications. For example, the deep-learning model 375 may include a Large Language Model (LLM), a Natural Language Processing (NLP) model, etc.

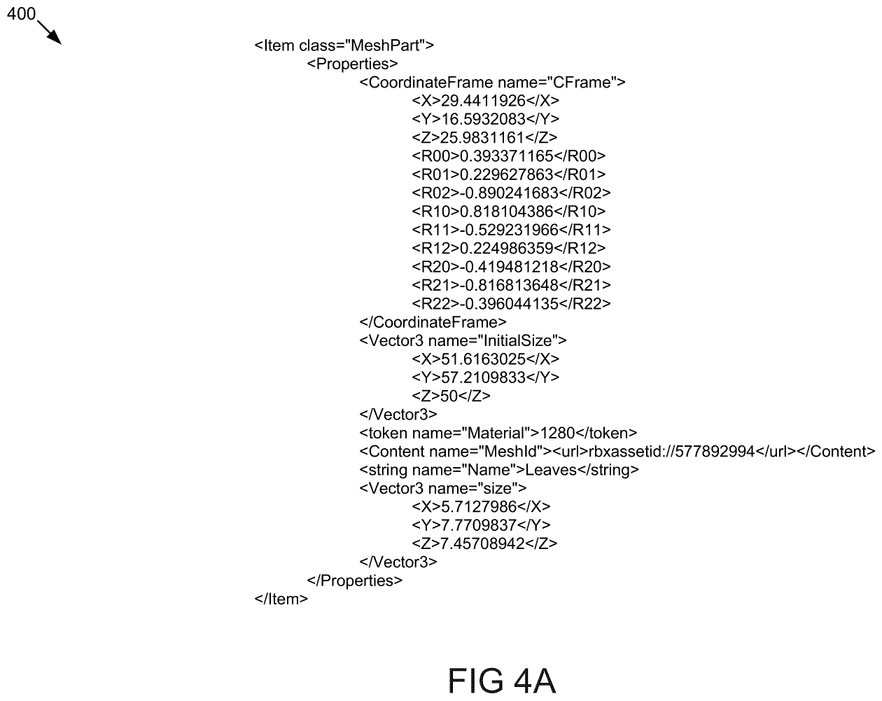

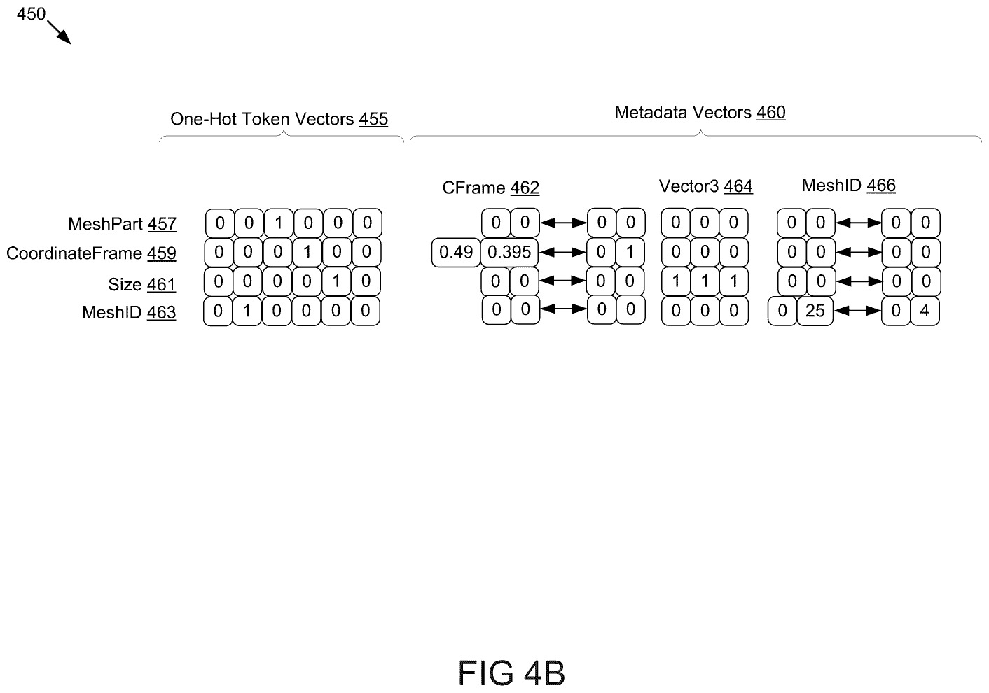

FIG. 4A is an example of a mesh part that is described by XML data 400, according to some embodiments described herein. The mesh part represents a 3D mesh, e.g., a mesh for an object that is part of a virtual environment. The XML data 400 for the mesh part includes a coordinate frame, an initial size, material, a mesh identifier, a name, and a current size (referred to as “size” in the XML data 400).

A coordinate frame describes a 3D position and orientation of an object in a virtual environment. The coordinate frame is made up of a point in space and a set of three perpendicular directions called the axes (i.e., x-, y-, and z-axes). A CFrame is a property that encodes the position and orientation of a coordinate frame with respect to the virtual environment's coordinate frame. In some embodiments, 12 numbers are used to describe the CFrame where the first three numbers describe the position of the origin of the CFrame with reference to the x-axis, the y-axis, and the z-axis, respectively, the next three numbers describe the direction vector of the x axis, the next three numbers describe the direction vector of the y axis, and the last three numbers describe the direction vector of the z axis. In this example, the CFrame is described by (29.4411926, 16.5932083, 25.9831161), (R00, R01, R02), (R10, R11, R12), and (R20, R21, R22).

The XML data 400 further includes an initial size, material, a mesh identifier (meshID), a name, and size. The initial size defines the initial mesh size. The material defines what kind of material the mesh should be treated as, which may be important for physics or audio functionality. In some embodiments, meshID is a URL (or other type of pointer) to a 3D mesh file. Name refers to a custom name that may be freely assigned. Size may be a current size of the mesh part in the scene.

Using a BPE tokenizer to tokenize the XML data 400 described in FIG. 4A results in 358 tokens. As described above, <Item class=“MeshPart”> alone requires seven tokens when tokenized using BPE.

FIG. 4B is an example 450 of how the XML data 400 in FIG. 4A is tokenized to include one-hot token vectors 455 and metadata vectors 460 to reduce the number of tokens, according to some embodiments described herein. The tags MeshPart 457, CoordinateFrame 459, Size 461, and MeshID 463 are converted into respective one-hot token vectors 455.

The tokenization engine 230 identifies the parts of XML data to represent with a token and the parts that are designated as metadata. Any type of data structure may be designated as metadata, but the tokenization engine 230 may optimally designate floating-point numbers and embeddings as metadata because it is difficult to efficiently represent floating-point numbers using a text-based tokenizer.

In some embodiments, a tokenization engine 230 generates one-hot tokens of tags such that <Item class=“MeshPart”> maps to one token instead of seven of a conventional technique and <CoordinateFrame name=“CFrame”> maps to one token instead of nine of a conventional technique. In some embodiments, the tokenization engine 230 removes the name field (e.g., <stringname=“Name”> Leaves</string> in FIG. 4A) since the name field is not needed to represent the 3D scene and is not needed to be contextually meaningful. As a result of tokenizing tags in the XML data 400 to a single token, the number of tokens (for the XML of FIG. 4A) is reduced from 358 using a BPE tokenizer to 186.

MeshPart 457 signifies the item class and is not associated with metadata. As a result, the metadata vectors 460 for the CFrame 462, the vector3 field 464, and the meshID field 466 are set to zero. CoordinateFrame 459 has a metadata vector 460 for CFrame 462 with a size of 12 floating-point vector that includes floating-point values. Size 461 is associated with a size of 3 for the vector3 464 metadata vector 460. The mesh ID field 463 is associated with a size of 1024 so that a mesh-specific embedding fits within the vector. In some embodiments, the mesh-specific embedding is generated using Principal Component Analysis (PCA), which is a linear dimensionality reduction technique that is used to transform a set of data points into a vector. Other embedding methods include a geometric embedding or an image based embedding.

Other types of tags in a data file may be used and treated in different ways. For example, a material tag as illustrated in FIG. 4A may be associated with metadata or it may be associated with custom tokens that represent the different types of materials (e.g., 45 different types). The tokenization engine 230 may or may not tokenize the name field.

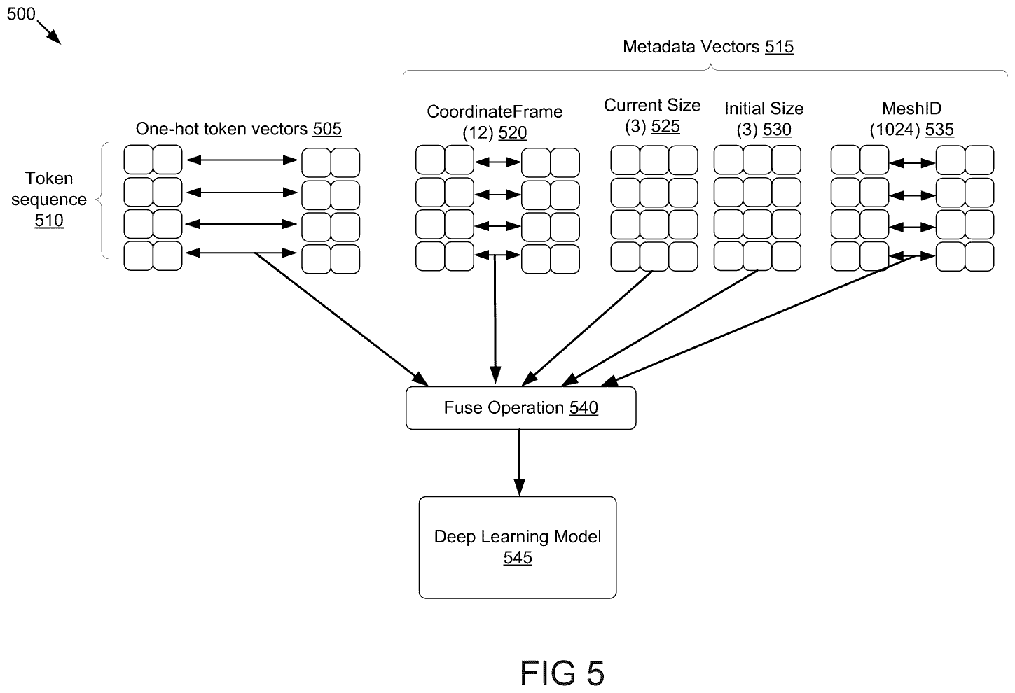

FIG. 5 is an example method 500 to combine a set of one-hot token vectors 505 and a set of metadata vectors 515, according to some embodiments described herein. The tokenization engine 230 generates one-hot token vectors 505 and combines them to form a token sequence 510.

The tokenization engine 230 generates metadata vectors 515. The metadata vectors 515 may include a coordinate frame 520, a current size 525, an initial size 530, and a mesh ID 535. The tokenization engine 230 may reserve a size 12 floating-point vector for the coordinate frame 520 into which the 12 number coordinate frame is injected. The tokenization engine 230 may similarly reserve three floating-point vectors for the current size 525 and three floating-point vectors for the initial size 530. The tokenization engine 230 may generate a custom token to represent the mesh ID 535. In this example, a PCA feature extraction technique was used to generate a 1024 floating-point vector for the mesh ID 535, but other techniques are also possible.

The table below represents different types of token names, the corresponding structure name in XML, and a size of the metadata vector generated from the metadata.

TABLE 1.0

| | | Size of |
|---|---|---|
| | | metadata |
| Token name | Represents structure in XML | vector |
| CoordinateFrame | <CoordinateFrame name=“CFrame” | 12 |
| | . . . | |
| | </CoordinateFrame> | |
| InitialSize | <Vector3 name=“InitialSize”> | 3 |
| | . . . | |
| | </Vector3> | |
| size | <Vector3 name=“size”> | 3 |
| | . . . | |
| | </Vector3> | |
| MeshId | <Content name=“MeshId”> | 1024 |
| | . . . | |
| | </Content> | |

The techniques described herein may be used with other types of metadata as well. For example, the metadata may include audio, image textures, a mesh part, light, a network service, etc.

The token sequence 510 is combined with metadata vectors 515. For example, the matrix of token vectors may be combined with a matrix of metadata features using a fuse operation 540. Although the metadata vectors 515 are illustrated as including a coordinate frame field 520, a current size field 525, an initial size field 530, and a mesh ID field 535, some of the fields may be omitted, other fields may be added, and the order of the fields may be different. In some embodiments, some of the token vectors do not have metadata. For those cases, the row in the metadata features for the corresponding token may be set to zero.

The fuse operation 540 may output a fused matrix. The fused matrix may be provided as input to a deep-learning model 545. The deep-learning model 545 may be a machine-learning model that uses the fused matrix for a variety of applications.

The deep-learning model 545 may output recommendations for content (e.g., a virtual experience, a movie, a game, etc.) based on the 3D scene as represented by the fused matrix provided as input. The deep-learning model 545 may output a recommendation for an advertisement that is placed inside a scene graph where the recommendation includes a location of the advertisement within the 3D scene and a type of advertisement. This can help improve the responsiveness of a virtual experience on a virtual experience platform by ensuring that the meshes that are high priority (affect the user experience most) are streamed with a greater priority than other meshes within the 3D scene when the virtual experience is rendered at least partially at a remote server but displayed at one or more client devices. The deep-learning model 545 may also identify suitable performance settings for rendering the scene, based on the input fused matrix.

The deep-learning model 545 may predict enhancements, extensions, or modifications to the 3D scene represented by the scene graph. The deep-learning model 545 may perform scene enhancement, e.g., generate virtual objects for placement in the 3D scene, identify virtual objects (e.g., 3D models or other assets) suitable for placement in the 3D scene, etc. and can help developers of virtual experiences speed up their workflow to design a 3D scene. In some implementations, the deep-learning model 545 may additionally be provided a text prompt (e.g., written by a developer) along with the fused matrix. For example, the developer may include text such as “please suggest a clock that I can place along the far side wall in this scene.” In response, the deep-learning model 545 may analyze the prompt and the fused matrix, e.g., to identify the far side wall, determine its dimensions, identify the scene characteristics (e.g., medieval dungeon), and identify automatically virtual assets that are clocks that can be placed along the far side wall, and any appropriate modifications (e.g., scaling, rotation, color change, or other transformations) for the clock before it is placed in the scene. In another example, the deep-learning model 545 may receive a prompt for a scene graph that matches characteristics described in the prompt. For example, the prompt may include a request for a scene graph of a village with a wooden church. The machine-learning model 240 identifies one or more scene graphs that match “wooden” and “church.”

In some embodiments, the deep-learning model 545 may identify terms of service violations. For example, the machine-learning model 240 may periodically check a live experience and determine whether the scene graph has patterns that are known terms of service violations. Because experiences load data dynamically, static analysis of the game files is not sufficient to identify the terms of service violations. In some embodiments, the deep-learning model 545 is trained to operate on the game state to improve the accuracy of detection of terms of service violations.

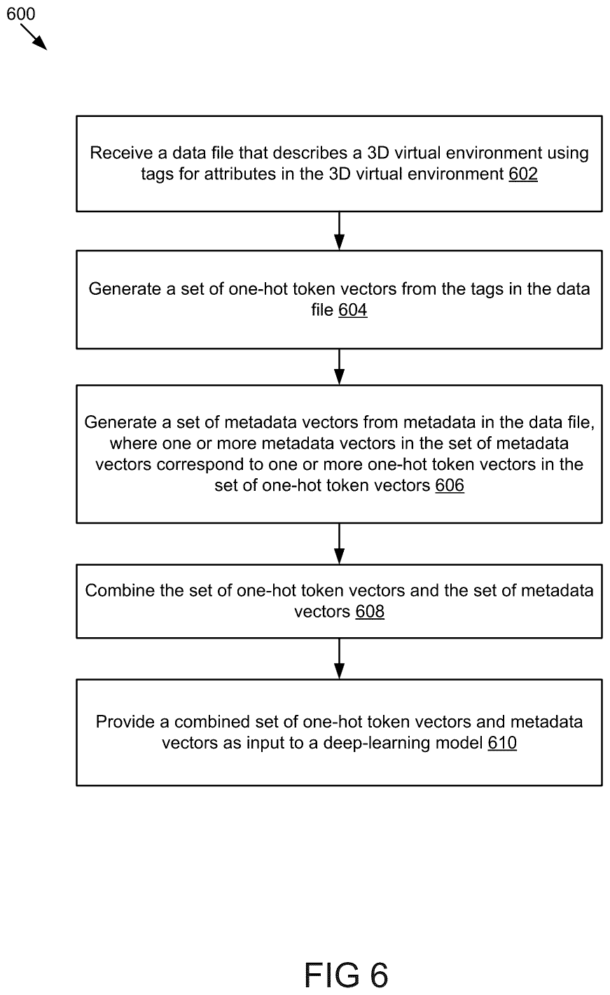

FIG. 6 is an example flow diagram of an example method 600 to generate a combined set of one-hot token vectors and metadata vectors. In some embodiments, all or portions of the method 600 are performed by the tokenization engine 230 stored on the online virtual experience server 202 or the virtual experience application 212 on the client device 210 in FIG. 2.

The method 600 may begin with block 602. At block 602 a data file is received that describes a 3D virtual environment using tags for attributes in the 3D virtual environment. The data file may be XML, JSON, YAML, USD, or other binary representations. Block 602 may be followed by block 604.

At block 604, a set of one-hot token vectors is generated from the tags in the data file. For example, <Item class=“MeshPart”> maps to a one-hot token, <CoordinateFrame name=“CFrame”> maps to a one-hot token, etc. The data file may include a tag for a name. In such cases, before the set of one-hot token vectors is generated, the tag for the name and a corresponding name may be removed from the data file. Block 604 may be followed by block 606.

At block 606, a set of metadata vectors is generated from metadata in the data file, where one or more metadata vectors in the set of metadata vectors correspond to one or more one-hot token vectors in the set of one-hot token vectors. The set of metadata vectors may include areas that are reserved for one or more floating point vectors. The one or more floating-point vectors may be associated with predetermined sizes that fit data associated with one or more of a coordinate frame, an initial size, a current size, a mesh identifier, light, image textures, a mesh part, audio, and/or a networking service.

In some embodiments, a one-hot token vector may not be associated with metadata. As a result, a metadata vector in the set of metadata vectors that is associated with a one-hot token vector that lacks metadata includes a row of metadata features that are set to zero to indicate an absence of metadata. Block 606 may be followed by block 608.

At block 608, the set of one-hot token vectors are combined with the set of metadata vectors. The set of one-hot token vectors may be combined with the set of metadata vectors using a fuse operation or by appending the metadata vectors to corresponding one-hot token vectors. The fuse operation may take a variety of forms including single-matrix multiplication and output from a deep neural network that includes different layers, such as convolutions and transformers. Block 608 may be followed by block 610.

At block 610, a combined set of one-hot token vectors and metadata vectors is provided as input to a deep-learning model. The deep-learning model may be a large language model (LLM), a natural language processing model, and/or any other sequence based deep-learning model. The deep-learning model may be trained using training data that includes a plurality of one-hot token vectors that are fused to a plurality of metadata vectors. In some embodiments, the deep-learning model outputs one or more selected from a group of a recommendation to generate content in the 3D virtual environment, an identification of a terms of service violation, a scene enhancement in the 3D virtual environment, an optimal performance setting, a streaming priority for a mesh in the 3D virtual environment, and combinations thereof.

### Example Computing Device

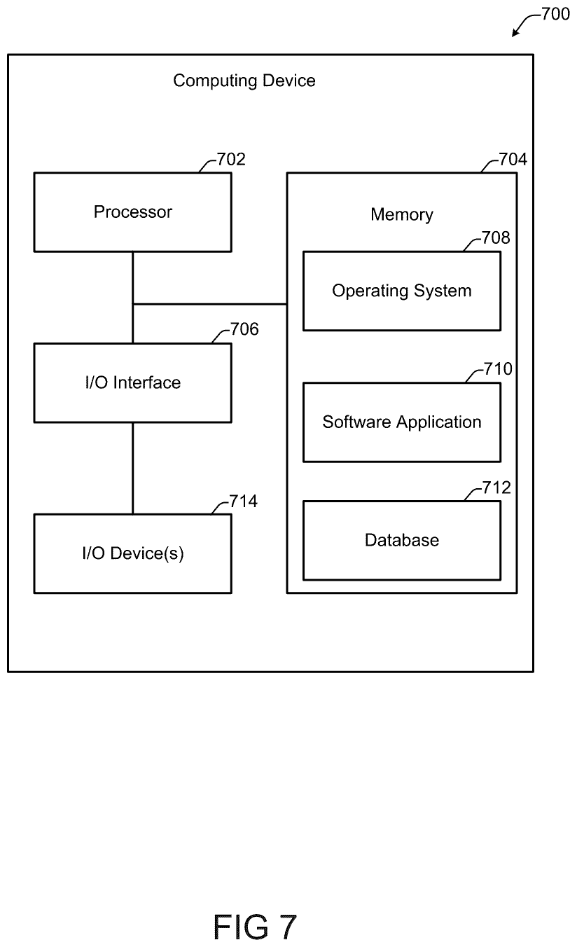

Hereinafter, a more detailed description of various computing devices that may be used to implement different devices and/or components illustrated in FIG. 2 is provided with reference to FIG. 7.

FIG. 7 is a block diagram of an example computing device 700 which may be used to implement one or more features described herein, in accordance with some embodiments. In one example, device 700 may be used to implement a computer device, (e.g., 202, 210 of FIG. 2), and perform appropriate operations as described herein. Computing device 700 can be any suitable computer system, server, or other electronic or hardware device. For example, the computing device 700 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some embodiments, device 700 includes a processor 702, a memory 704, input/output (I/O) interface 706, and audio/video input/output devices 714 (e.g., display screen, touchscreen, display goggles or glasses, audio speakers, headphones, microphone, etc.).

Processor 702 can be one or more processors and/or processing circuits to execute program code and control basic operations of the device 700. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 704 is typically provided in device 700 for access by the processor 702, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 702 and/or integrated therewith. Memory 704 can store software operating on the server device 700 by the processor 702, including an operating system 708, software application 710 and associated data 712. In some embodiments, the applications 710 can include instructions that enable processor 702 to perform the functions described herein. Software application 710 may include some or all of the functionality required to generate tokens. In some embodiments, one or more portions of software application 710 may be implemented in dedicated hardware such as an application-specific integrated circuit (ASIC), a programmable logic device (PLD), a field-programmable gate array (FPGA), a machine learning processor, etc. In some embodiments, one or more portions of software application 710 may be implemented in general purpose processors, such as a central processing unit (CPU) or a graphics processing unit (GPU). In various embodiments, suitable combinations of dedicated and/or general purpose processing hardware may be used to implement software application 710.

For example, software application 710 stored in memory 704 can include instructions for retrieving user data, for displaying/presenting avatars and/or other functionality or software such as the modeling component 130, VE Engine 104, and/or VE Application 112. Any of software in memory 704 can alternatively be stored on any other suitable storage location or computer-readable medium. In addition, memory 704 (and/or other connected storage device(s)) can store instructions and data used in the features described herein. Memory 704 and any other type of storage (magnetic disk, optical disk, magnetic tape, or other tangible media) can be considered “storage” or “storage devices.”

I/O interface 706 can provide functions to enable interfacing the server device 700 with other systems and devices. For example, network communication devices, storage devices (e.g., memory and/or data store 106), and input/output devices can communicate via interface 706. In some embodiments, the I/O interface can connect to interface devices including input devices (keyboard, pointing device, touchscreen, microphone, camera, scanner, etc.) and/or output devices (display device, speaker devices, printer, motor, etc.).

For ease of illustration, FIG. 7 shows one block for each of processor 702, memory 704, I/O interface 706, software blocks 708 and 710, and database 712. These blocks may represent one or more processors or processing circuitries, operating systems, memories, I/O interfaces, applications, and/or software modules. In other embodiments, device 700 may not have all of the components shown and/or may have other elements including other types of elements instead of, or in addition to, those shown herein. While the online server 202 is described as performing operations as described in some embodiments herein, any suitable component or combination of components of online server 202, or similar system, or any suitable processor or processors associated with such a system, may perform the operations described.

A user device can also implement and/or be used with features described herein. Example user devices can be computer devices including some similar components as the device 700, e.g., processor(s) 702, memory 704, and I/O interface 706. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 714, for example, can be connected to (or included in) the device 700 to display images pre- and post-processing as described herein, where such display device can include any suitable display device, e.g., an LCD, LED, or plasma display screen, CRT, television, monitor, touchscreen, 3-D display screen, projector, or other visual display device. Some embodiments can provide an audio output device, e.g., voice output or synthesis that speaks text.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various embodiments. In some embodiments, blocks and operations can be performed multiple times, in a different order, and/or at different times in the methods.

In some embodiments, some or all of the methods can be implemented on a system such as one or more client devices. In some embodiments, one or more methods described herein can be implemented, for example, on a server system, and/or on both a server system and a client system. In some embodiments, different components of one or more servers and/or clients can perform different blocks, operations, or other parts of the methods.

One or more methods described herein (e.g., method 600) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) executing on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the live feedback data for output (e.g., for display). In another example, computations can be split between the mobile computing device and one or more server devices.

In situations in which certain embodiments discussed herein may obtain or use user data (e.g., user demographics, user behavioral data, user contextual data, user settings for advertising, etc.) users are provided with options to control whether and how such information is collected, stored, or used. That is, the embodiments discussed herein collect, store and/or use user information upon receiving explicit user authorization and in compliance with applicable regulations.

Users are provided with control over whether programs or features collect user information about that particular user or other users relevant to the program or feature. Each user for which information is to be collected is presented with options (e.g., via a user interface) to allow the user to exert control over the information collection relevant to that user, to provide permission or authorization as to whether the information is collected and as to which portions of the information are to be collected. In addition, certain data may be modified in one or more ways before storage or use, such that personally identifiable information is removed. As one example, a user's identity may be modified (e.g., by substitution using a pseudonym, numeric value, etc.) so that no personally identifiable information can be determined. In another example, a user's geographic location may be generalized to a larger region (e.g., city, zip code, state, country, etc.).

Although the description has been described with respect to particular embodiments thereof, these particular embodiments are merely illustrative, and not restrictive. Concepts illustrated in the examples may be applied to other examples and embodiments.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular embodiments. Different programming techniques may be employed, e.g., procedural or object-oriented. The routines may execute on a single processing device or multiple processors. Although the steps, operations, or computations may be presented in a specific order, the order may be changed in different particular embodiments. In some embodiments, multiple steps or operations shown as sequential in this specification may be performed at the same time.

What is claimed is:

1. A computer-implemented method comprising:
receiving a data file that describes a three-dimensional (3D) virtual environment, wherein the data file includes tags for attributes in the 3D virtual environment;
generating a set of one-hot token vectors from the tags in the data file;
generating a set of metadata vectors from metadata in the data file, wherein one or more metadata vectors in the set of metadata vectors correspond to one or more one-hot token vectors in the set of one-hot token vectors;
combining the set of one-hot token vectors and the set of metadata vectors; and
providing a combined set of one-hot token vectors and metadata vectors as input to a deep-learning model.

2. The method of claim 1, wherein the set of metadata vectors includes areas that are reserved for one or more floating-point vectors.

3. The method of claim 2, wherein the one or more floating-point vectors are associated with predetermined sizes that fit data associated with one or more selected from a group of a coordinate frame, an initial size, a current size, a mesh identifier, light, image textures, a mesh part, audio, a networking service, and combinations thereof.

4. The method of claim 1, wherein a metadata vector in the set of metadata vectors that is associated with a one-hot token vector that lacks metadata includes metadata features that are set to zero to indicate an absence of metadata.

5. The method of claim 1, wherein the deep-learning model outputs one or more selected from a group of a recommendation to generate content in the 3D virtual environment, an identification of a terms of service violation, a scene enhancement in the 3D virtual environment, an optimal performance setting, a streaming priority for a mesh in the 3D virtual environment, and combinations thereof.

6. The method of claim 1, wherein the deep-learning model is trained using training data that includes a plurality of one-hot token vectors that are fused to a plurality of metadata vectors.

7. The method of claim 1, wherein the data file is of a filetype is selected from a group of an extensible markup language (XML), JSON, YAML, and Universal Scene Description (USD).

8. The method of claim 1, wherein the tags in the data file include a tag for a name, and the method further comprises:
before generating the set of one-hot token vectors, removing the tag for the name and the name from the data file.

9. The method of claim 1, wherein combining the set of one-hot token vectors and the set of metadata vectors is performed using a fuse operation.

10. A system comprising:
a processor; and
a memory coupled to the processor, with instructions stored thereon that, when executed by the processor, cause the processor to perform operations comprising:
receiving a data file that describes a three-dimensional (3D) virtual environment, wherein the data file includes tags for attributes in the 3D virtual environment;
generating a set of one-hot token vectors from the tags in the data file;
generating a set of metadata vectors from metadata in the data file, wherein one or more metadata vectors in the set of metadata vectors correspond to one or more one-hot token vectors in the set of one-hot token vectors;
combining the set of one-hot token vectors and the set of metadata vectors; and
providing a combined set of one-hot token vectors and metadata vectors as input to a deep-learning model.

11. The system of claim 10, wherein the set of metadata vectors includes areas that are reserved for one or more floating-point vectors.

12. The system of claim 11, wherein the one or more floating-point vectors are associated with predetermined sizes that fit data associated with one or more selected from a group of a coordinate frame, an initial size, a current size, a mesh identifier, light, image textures, a mesh part, audio, a networking service, and combinations thereof.

13. The system of claim 10, wherein a metadata vector in the set of metadata vectors that is associated with a one-hot token vector that lacks metadata includes metadata features that are set to zero to indicate an absence of metadata.

14. The system of claim 10, wherein the deep-learning model is selected from a group of a large language model, a natural language processing model, and combinations thereof.

15. The system of claim 10, wherein the deep-learning model is trained using training data that includes a plurality of one-hot token vectors that are fused to a plurality of metadata vectors.

16. A non-transitory computer-readable medium with instructions that, when executed by one or more processors at a user device, cause the one or more processors to perform operations, the operations comprising:
receiving a data file that describes a three-dimensional (3D) virtual environment, wherein the data file includes tags for attributes in the 3D virtual environment;
generating a set of one-hot token vectors from the tags in the data file;
generating a set of metadata vectors from metadata in the data file, wherein one or more metadata vectors in the set of metadata vectors correspond to one or more one-hot token vectors in the set of one-hot token vectors;
combining the set of one-hot token vectors and the set of metadata vectors; and
providing a combined set of one-hot token vectors and metadata vectors as input to a deep-learning model.

17. The non-transitory computer-readable medium of claim 16, wherein the set of metadata vectors includes areas that are reserved for one or more floating-point vectors.

18. The non-transitory computer-readable medium of claim 17, wherein the one or more floating-point vectors are associated with predetermined sizes that fit data associated with one or more selected from a group of a coordinate frame, an initial size, a current size, a mesh identifier, light, image textures, a mesh part, audio, a networking service, and combinations thereof.

19. The non-transitory computer-readable medium of claim 16, wherein a metadata vector in the set of metadata vectors that is associated with a one-hot token vector that lacks metadata includes metadata features that are set to zero to indicate an absence of metadata.

20. The non-transitory computer-readable medium of claim 16, wherein the deep-learning model is selected from a group of a large language model, a natural language processing model, and combinations thereof.
